(19) United States
(12) Patent Application Publication
(10) Pub. No.: US 2017/0206148 A1
(43) Pub. Date: Jul. 20, 2017

(54) CROSS-REGION FAILOVER OF APPLICATION SERVICES

(71) Applicant: Facebook, Inc., Menlo Park, CA (US)

(72) Inventors: Vikas Mehta, Lynnwood, WA (US); Haobo Xu, Palo Alto, CA (US); Jason Curtis Jenks, Lynnwood, WA (US); Hairong Kuang, San Jose, CA (US); Pierre-Luc Bertrand, New York, NY (US); Andrei Lutsenko, Menlo Park, CA (US); Zhenhua Guo, Woodinville, WA (US); Jun Ying, Seattle, WA (US)

(21) Appl. No.: 15/001,741

(22) Filed: Jan. 20, 2016

(51) Int. Cl. G06F 11/20; H04L 29/08

(52) U.S. Cl. CPC G06F 11/203; H04L 67/1095; H04L 67/1097; G06F 2201/805

(57) ABSTRACT

The disclosure is directed to a failover mechanism for failing over an application service, e.g., a messaging service, from servers in a first region to servers in a second region. Data is stored as shards in which each shard contains data associated with a subset of the users. Data access requests are served by a primary region of the shard. A global shard manager manages failing over the application service from a current primary region of a shard to a secondary region of the shard. The current primary determines whether a criterion for failing over, e.g., a replication lag between the primary and the secondary regions is within a threshold, and if it is within the threshold, the failover process waits until the lag is zero. After the replication lag is zero, the application service is failed over to the second region, which then becomes the primary for the shard.

### BACKGROUND

A failover process can be switching an application to a redundant or a standby server computing device (“server”), a hardware component or a computer network typically upon unavailability of the previously active server, hardware component, or the network. A server can become unavailable due to a failure, abnormal termination, or planned termination for performing some maintenance work. The failover process can be performed automatically, e.g., without human intervention and/or manually. The failover processes can be designed to provide high reliability and high availability of data and/or services. Some failover processes backup or replicate data to off-site locations, which can be used in case the infrastructure at the primary location fails. Although the data is backed up to off-site locations, the applications to access that data may not be made available, e.g., because the failover processes may not failover the application. Accordingly, the users of the application may have to experience a downtime—a period during which the application is not available to the users. Such failover processes can provide high reliability but may not be able to provide high availability.

Some failover processes failover both the application and the data. However, the current failover processes are inefficient, as they may not provide high reliability and high availability. For example, the current failover process can failover the application to a standby server and serve users requests from the standby server. However, the current failover processes may not ensure that the data is replicated entirely from the primary system to the stand-by system. For example, the network for replicating the data may be overloaded and data may not be replicated entirely or is being replicated slowly. When a user issues a data access request, e.g., for obtaining some data, the stand-by system may not be able to obtain the data, thereby causing the user to experience data loss. That is, the failover process may provide high availability but not high reliability.

Further, the current failover processes can be even more inefficient in cases where the failover has to be performed from a set of servers located in a first region to a set of servers located in a second region. The regions can be different geographical locations that are farther apart, e.g., latency between the systems of different regions is significant. For example, while it can take a millisecond to determine if a server within a specified region has failed, it can take few hundreds of milliseconds to determine if a server in another region has failed from the specified region. Current failover processes may not be able to detect the failures across regions reliably and therefore, if the application has to be failed over from the first region to the second region, the second region may not be prepared to host the application yet.

### BRIEF DESCRIPTION OF THE DRAWINGS

FIG. 1 is a block diagram illustrating an example of an application service and shards associated with the application service, consistent with various embodiments.

FIG. 2 depicts a block diagram illustrating an example assignment of shards to multiple regions and application servers, consistent with various embodiments.

FIG. 3 is a block diagram illustrating an environment in which the disclosed embodiments may be implemented.

FIG. 4 is a block diagram illustrating the environment of FIG. 3 after the failover process is completed successfully, consistent with various embodiments.

FIG. 5 is a state transition diagram for failing over the application service from one region to another region, consistent with various embodiments.

FIG. 6 is a flow diagram of a process of routing a data access request from a user to an application server, consistent with various embodiments.

FIG. 7 is a flow diagram of a process of failing over an application service from one region to another region, consistent with various embodiments.

FIG. 8 is a flow diagram of a process of confirming if one or more criteria for failing over an application service from one region to another region are satisfied, consistent with various embodiments.

FIG. 9 is a flow diagram of a process of promoting a region to the primary region of a specified shard, consistent with various embodiments.

FIG. 10 is a block diagram of a processing system that can implement operations, consistent with various embodiments.

### DETAILED DESCRIPTION

Embodiments are disclosed for a failover mechanism to fail over an application service, e.g., a messenger service in a social networking application, executing on a first set of server computing devices (“servers”) in a first region to a second set of servers in a second region. The failover mechanism supports both planned failover and unplanned failover of the application service. The failover mechanism can failover the application service while still providing high availability of the application service with minimum data loss. Further, in a planned failover process, the failover mechanism can failover the application service to the second region without any data loss and without disrupting the availability of the application service to users of the application service.

The application service can be implemented at a number of server computing devices (“servers”). The servers can be distributed across a number of regions, e.g., geographical regions such as continents, countries, etc. Each region can have a number of the servers and an associated data storage system (“storage system”) in which the application service can store data. The application service can store data, e.g., user data, as multiple shards in which each shard contains data associated with a subset of the users. A shard can be stored at multiple regions in which one region is designated as a primary region and one or more regions are designated as secondary regions for the shard. A primary region for a specified shard can be a region that is assigned to process and/or serve all data access requests from users associated with the specified shard. For example, data access requests from users associated with the specified shard are served by the servers in the primary region for the specified shard. The secondary region can store a replica of the specified shard, and can also be used as a new primary region for the specified shard in an event the current primary region for the specified shard is unavailable, e.g., due to a failure.

When a data access request, e.g., a message, is received from a user, the message is processed by a server in the primary region for the specified shard with which the user is associated, replicated to the storage system in the secondary region for the shard, and stored at the storage system in the primary region. A global shard manager computing device (“global shard manager”) can manage failing over the application service from a first region, e.g., the current primary region for a specified shard, to a second region, e.g., one of the secondary regions for the specified shard. As a result of the failover, the second region can become the new primary region for the specified shard, and the first region, if still available, can become the secondary region for the specified shard.

The failover can be a planned failover or an unplanned failover. In the event of the planned failover, the global shard manager can trigger the failover process by designating one of the secondary regions, e.g., the second region, as the expected primary region for the specified shard. In some embodiments, shard assignments to servers within a region can be managed using a regional shard manager computing device (“regional shard manager”). A first regional shard manager associated with the current primary region, e.g., the first region, determines whether one or more criteria for failing over the application service are satisfied. For example, the first regional shard manager determines whether there is a replication lag between the current primary region and the expected primary region. If there is no replication lag, e.g., the storage system of the expected primary region has all of the data associated with the specified shard that is stored at the current primary region, the first regional shard manager requests the global shard manager to promote the expected primary region, e.g., the second region, as the new primary region for the specified shard, and to demote the current primary region, e.g., the first region, to the secondary region for the specified shard. Any necessary services and processes for serving data access requests from the users associated with the specified shard are started at the servers in the second region. Any data access requests from the users associated with the specified shard are now forwarded to the servers in the second region, as the second region is the new primary region for the specified shard.

Referring back to determining whether there is a replication lag, if there is a replication lag, then the first regional shard manager can determine whether the replication lag is within a specified threshold, e.g., whether the storage system of the expected primary region has most of the data associated with the specified shard stored at the current primary region. If the replication lag is within the specified threshold, the first regional shard manager can wait until there is no replication lag. While the first regional shard manager is waiting for the replication lag to become zero, e.g., all data associated with the specified shard is copied to the storage system at the second region, the first regional shard manager can block any incoming data access requests to the first region from the users associated with the specified shard so that the replication lag does not increase. After the replication lag becomes zero, the first regional shard manager can instruct the global shard manager to promote the expected primary region, e.g., the second region, as the primary region and demote the current primary region, e.g., the first region, to being the secondary region for the specified shard. After the second region is promoted to the primary region, the first region can also forward the blocked data access requests to the second region. Referring back to determining whether the replication lag is below the specified threshold, if the first regional shard manager determines that the replication is above the specified threshold, it can indicate to the global shard manager that the fail over process may not be initiated.

In the event of the unplanned failover, e.g., due to servers failing in the primary region, the global shard manager instructs one of the secondary regions of the specified shard, e.g., the second region, to become the new primary region and fails over the application service to the new primary region. If the replication lag of the new primary region is above the specified threshold, the application service can be unavailable to the users associated with the specified shard up until the replication lag is below the threshold or is zero. In some embodiments, the application service can be made immediately available to the users regardless of the replication lag, however, the users may experience a data loss in such a scenario.

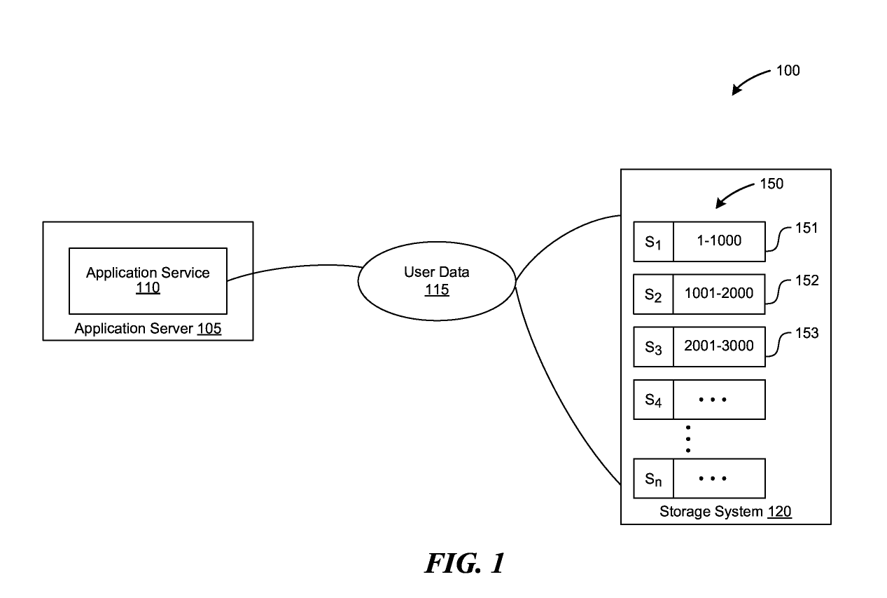

Turning now to the figures, FIG. 1 is a block diagram illustrating an example 100 of an application service and shards associated with the application service, consistent with various embodiments. The application service 110 can be a social networking application that allows the users to manage user profile data, post comments, photos, or can be a messaging service of the social networking application that enables the users to exchange messages. The application service 110 can be executed at an application server 105. As described above, the application service 110 can be associated with a dataset. For example, the application service 110 can be associated with user data 115 of the users of the application service 110. The dataset can be partitioned into a number of shards 150, each of which can contain a portion of the dataset. In some embodiments, a shard is a logical partition of data in a database. Each of the shards 150 can contain data of a subset of the users. For example, a first shard “S₁” 151 can contain data associated with one thousand users, e.g., users with ID “1” to “1000” as illustrated in the example 100. Similarly, a second shard “S₂” 152 can contain data associated with users of ID “1001” to “2000”, and a third shard “S₃” 153 can contain data associated with users of ID “2001” to “3000”. The shards 150 can be stored at a distributed storage system 120 associated with the application service 110. The distributed storage system 120 can be distributed across multiple regions and a region can store at least a subset of the shards 150. In some embodiments, the application service 110 can execute on a number of servers.

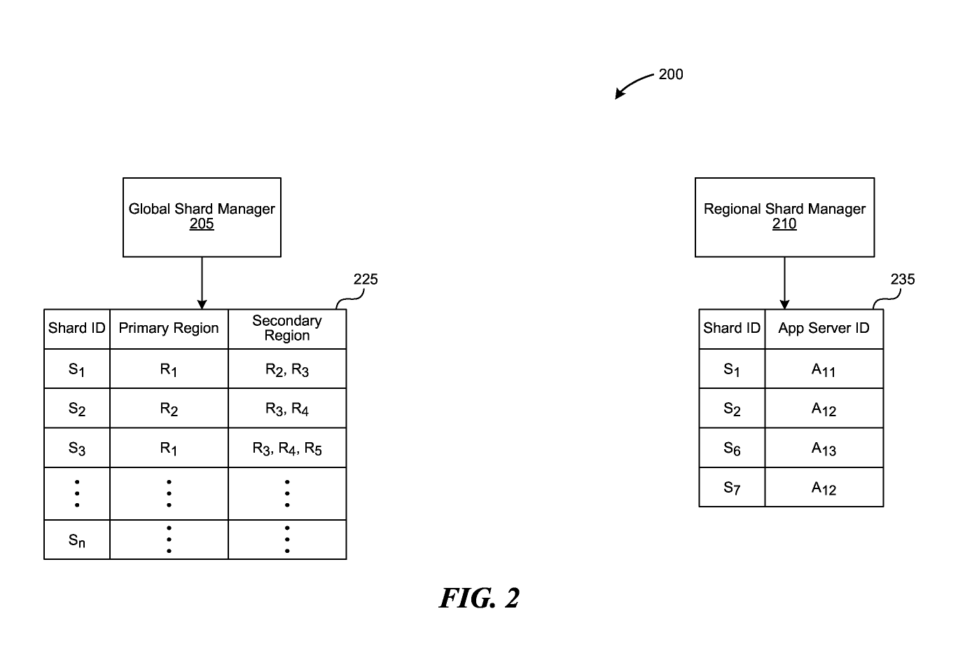

FIG. 2 depicts a block diagram illustrating an example 200 of assignment of shards to multiple regions and application servers, consistent with various embodiments. A global shard manager 205 can manage the assignments of primary and secondary regions for the shards, e.g., shards 150 of FIG. 1. In some embodiments, the assignments are input by a user, e.g., an administrator associated with the application service 110. In some embodiments, the global shard manager 205 can determine the shard assignments based on region-shard assignment policies provided by the administrator. The global shard manager 205 can include a shard assignment component (not illustrated) that can be used for defining and/or determining the region-shard assignments based on the region-shard assignment policies. The global shard manager 205 can store the assignments of the regions to the shards in a shard-region assignment table 225. In the example 200, for the first shard “S₁,” a first region “R₁” is assigned as the primary region and second and third regions “R₂” and “R₃” are assigned as the secondary regions. The secondary regions “R₂” and “R₃” store a replica of the first shard “S₁.” In some embodiments, two different shards can have the same region as the primary region. For example, both shards “S₁” and “S₃” have the first region as the primary region. In some embodiments, different shards can have different number of secondary regions. For example, while shards “S₁” and “S₂” have two secondary regions each, shard “S₃” is assigned to three secondary regions.

Also illustrated in the example 200 is assignment of shards to application servers within a region. A regional shard manager 210 can manage the assignment of shards to the application servers. In some embodiments, the assignments are input by the administrator. In some embodiments, the regional shard manager 210 can determine the shard assignments based on shard-server assignment policies provided by the administrator. The regional shard manager 210 can store the shard-server assignments in a shard-server assignment table 235. In the example 200, the first shard “S₁,” is assigned to an application server “A₁₁.” This mapping can indicate that data access requests from users associated with shard “S₁” are processed by the application server “A₁₁.” In some embodiments, each of the regions can have a regional shard manager, such as the regional shard manager 210.

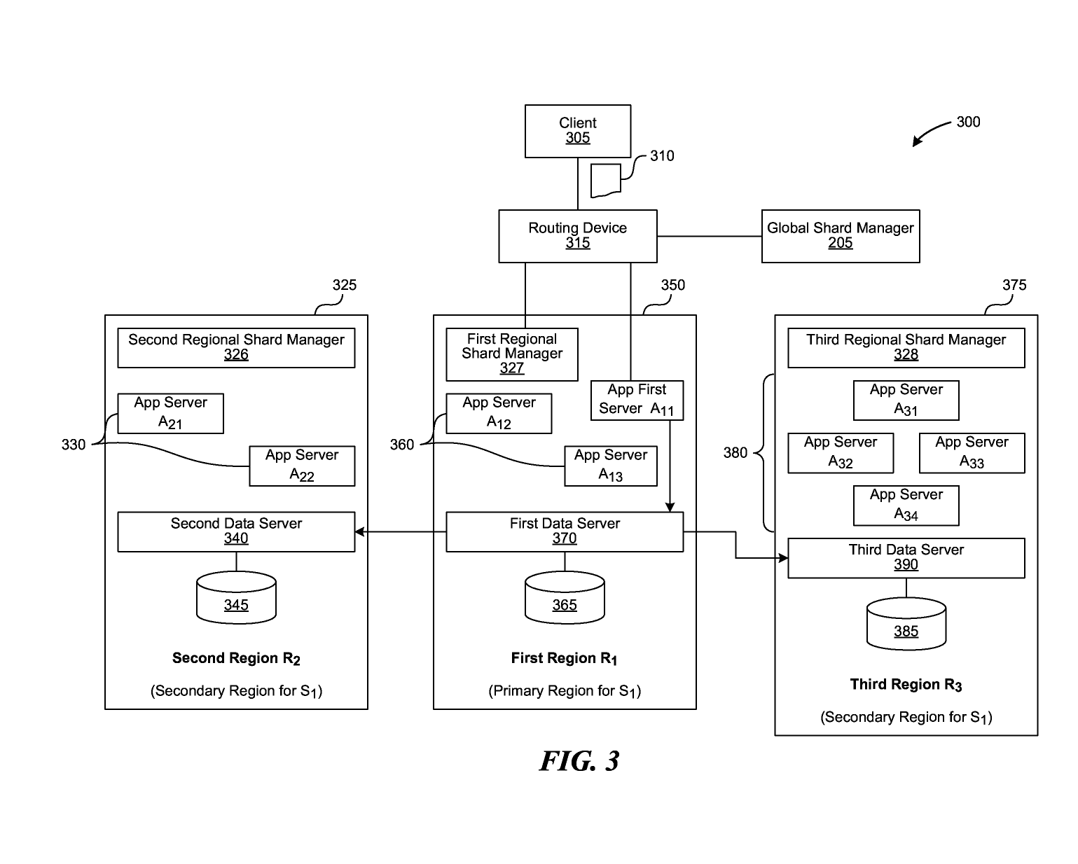

FIG. 3 depicts a block diagram illustrating an environment 300 in which the disclosed embodiments may be implemented. An application service, e.g., the application service 110 of FIG. 1, can be implemented on a number of application servers, and the application servers can be distributed across multiple regions, e.g., a first region 350, a second region 325 and a third region 375. The first region 350 includes a first set of application servers 360, the second region 325 includes a second set of application servers 330 and the third region 375 includes a third set of application servers 380. Further, each of the regions is associated with a data storage layer in that particular region. For example, the first region 350 is associated with a first data server 370 that can store data at the associated storage system 365, the second region 325 with a second data server 340 that can store data at associated storage system 345 and the third region 375 with a third data server 390 that can store data at the associated storage system 385.

In some embodiments, each of the regions can be a different geographical region, e.g., a country, continent. Typically, a response time for accessing data at the storage system within a particular region is lesser than that of accessing data from the storage system in a different region from that of the application server. In some embodiments, two systems are considered to be in different regions if the latency between them is beyond a specified threshold.

As described at least with reference to FIG. 2, the data associated with the application service 110 can be stored as a number of shards, e.g., shards 150, and the shards 150 can be assigned to different regions. For example, for the first shard “S₁,” the first region 350 is assigned as the primary region and the second region 325 and the third region 375 are assigned as the secondary regions. As described above, the primary region is a region that is designated to process data access requests from a user associated with the shard for which the region is primary. The secondary regions store a replica of the shard, e.g., the first shard “S₁,” stored in a primary region. In some embodiments, the global shard manager 205 manages the region-shard assignments. Each of the regions includes a regional shard manager that facilitates server-shard assignments within that region. For example, the first region 350 includes a first regional shard manager 327 that can facilitate server-shard assignments within the first region 350. Similarly, the second region 325 includes a second regional shard manager 326 and the third region 375 includes a third regional shard manager 328. In some embodiments, the regional shard managers 326, 327 and 328 are similar to the regional shard manager 210 of FIG. 2.

A data access request from a user is served by a specified region and a specified application server in the specified region based on a specified shard with which the user is associated. When a user issues a data access request 310 from a client computing device (“client”) 305, a routing computing device (“routing device”) 315 determines a shard with which the user is associated. In some embodiments, the routing device 315, the global shard manager 205 and/or another service (not illustrated) can have information regarding the mapping of the users to the shards, e.g., user identification (ID) to shard ID mapping. For example, the user is associated with the first shard 151. After determining the shard ID, the routing device 315 can determine the primary region for the first shard 151 using the global shard manager 205. For example, the routing device 315 determines that the first region 250 is designated as the primary region for the first shard 151. The routing device 315 then contacts the regional shard manager of the primary region, e.g., the first regional shard manager 327 to determine the application server to which the data access request is to be routed. For example, the first regional shard manager 327 indicates, e.g., based on the shard-server assignment table 235, that the data access requests for the first shard 151 is to be served by the application server “A₁₁” in the first region 350. The routing device 315 sends the data access request 310 to the application server “A₁₁” accordingly.

The application server “A₁₁” processes the data access request 310. For example, if the data access request 310 is a request for sending data, e.g., a message to another user, the application server “A₁₁” sends the message to another user, sends the message to the first data server 370 for storing the message at the first storage system 365. In some embodiments, the first data server 370 also replicates the data received from the data access request 310 to the secondary regions, e.g., the second region 325 and the third region 375, of the first shard 151. The data servers at the respective secondary regions receive the data and store the received data at their corresponding storage systems.

In some embodiments, the application service 110 can be failed over from a first region 350 to another region for various reasons, e.g., for performing maintenance work on the application servers 360, or the application servers 360 become unavailable due to a failure. The failover can be a planned failover or an unplanned failover. The global shard manager 205 and the regional shard managers, e.g., the regional shard managers of the primary region and one of the secondary regions that is expected to be the new primary region can coordinate with each other to perform the failover process for a specified shard. As a result of the failover process, the current primary region of the specified shard is demoted to be a secondary region for the specified shard and one of the current secondary regions is promoted to be the new primary region for the specified shard. In some embodiments, the global shard manager 205 determines the secondary region that has to be promoted as the new primary region for the specified shard. In some embodiments, the failover process is performed per shard. However, the failover process can be performed for multiple shards in parallel or in sequence.

Consider that the application service 110 has to be failed over for the first shard “S₁” 151 from the first region 350 to the second region 325. The first region 350 is the current primary region (e.g., primary region prior to the failover process) of the first shard 151. The second region 325 and the third region 375 are the current secondary regions for the first shard 151, and the second region 325 is to be the new primary region for the first shard 151 (as a result of the failover process).

The global shard manager 205 can trigger the failover process by updating a value of an expected primary region of the first shard 151, e.g., to the second region 325. In some embodiments, a request receiving component (not illustrated) in the global shard manager 205 can receive the request for failing over from the administrator. The administrator can update the expected primary region attribute value using the request receiving component. Upon a change in value of the expected primary region of the first shard 151, the regional shard manager of the current primary region for the first shard 151, e.g., the first regional shard manager 327 of the first region 350, determines whether one or more criteria for failing over the application service 110 is satisfied. In some embodiments, the regional shard managers have a criteria determination component (not illustrated) that can be used to determine whether the one or more criteria are satisfied for performing the failover. The administrator may also input the criteria using the criteria determination component. For example, a replication lag of data between the second storage system 345 of the expected primary region and the first storage system 365 of the current primary region can be one of the criteria.

If there is no replication lag, e.g., the second storage system 345 of the expected primary region has all of the data associated with the first shard 151 that is stored at the current primary region, the first regional shard manager 327 requests the global shard manager 205 to promote the expected primary region, e.g., the second region 325, as the new primary region for the first shard 151. The first regional shard manager 327 can also demote the current primary region, e.g., the first region 350, to being the secondary region for the first shard 151. Any necessary services and processes for serving data access requests from the users associated with the first shard 151 are started at the second set of application servers 330 in the new primary region, e.g., the second region 325. Any data access requests from the users associated with the first shard 151 are now forwarded to the second set of application servers 330 in the second region 325. The global shard manager 205 also indicates the second regional shard manager 326 to update information indicating that the second region 325 is the primary region for the first shard 151.

Referring back to determining whether there is a replication lag, if there is a replication lag, then the first regional shard manager 327 can determine whether the replication lag is within a specified threshold. If the replication lag is within the specified threshold, the first regional shard manager 327 can wait until there is no replication lag. In some embodiments, data replication between regions can be performed via the data servers of the corresponding regions. While the first regional shard manager 327 is waiting for the replication lag to become zero, e.g., all data associated with the first shard 151 is copied to the second storage system 345 at the second region 325, the first regional shard manager 327 can block any incoming data access requests to the first region 350 from the users associated with the first shard 151 so that the replication lag does not increase.

Once the replication lag becomes zero, the first regional shard manager 327 can instruct the global shard manager 205 to promote the expected primary region, e.g., the second region 325, as the new primary region and demote the current primary region, e.g., the first region 350, to being the secondary region. After the second region 325 is promoted to the primary region for the first shard 151, the first region 350 can also forward any blocked data access requests to the second region 325. Referring back to determining whether the replication lag is below the specified threshold, if the first regional shard manager 327 determines that the replication is above the specified threshold, it can indicate to the global shard manager 205 that the fail over process may not be initiated, e.g., as a significant amount of data may be lost if the process is failed over.

As a result of the failover process, the global shard manager 205 can update the shard-region assignments, e.g., in the shard-region assignment table 225 to indicate the second region 325 is the primary region for the first shard 151. Similarly, the first regional shard manager 327 can update the shard-server assignments, e.g., in the shard-server assignment table 235.

In the event of the unplanned failover, e.g., due to application servers failing in the first region 350, the global shard manager 205 instructs the second region 325 to become the new primary region for the first shard 151 and fails over the application service 110 to the new primary region regardless of the replication lag between the first region 350 and the second region 325. If the replication lag of the new primary region is above the specified threshold, the application service 110 can be unavailable to the users associated with the first shard 151, e.g., up until the replication lag is below the threshold or is zero. In some embodiments, the application service can be made immediately available to the users regardless of the replication lag, however, the users may experience data loss in such a scenario.

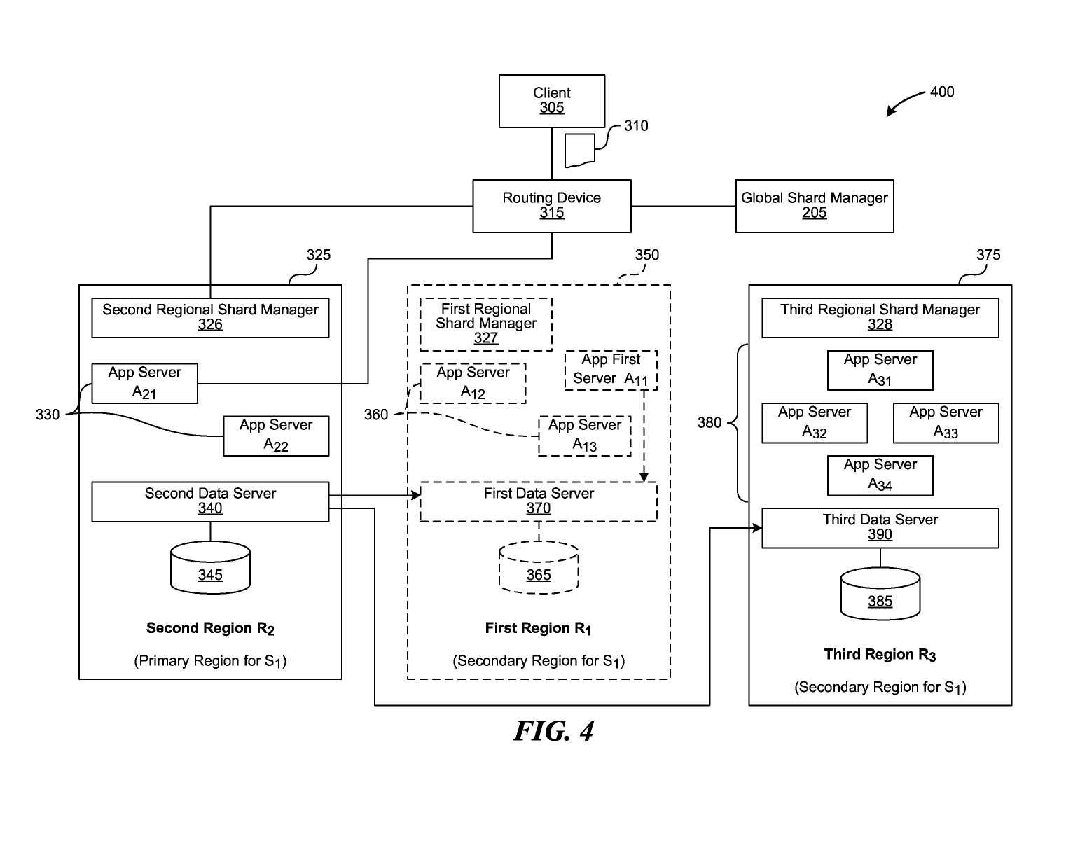

FIG. 4 is a block diagram illustrating the environment of FIG. 3 after the failover process is completed successfully, consistent with various embodiments. The data access requests from users associated with the first shard 151 are now forwarded to the second set of application servers 330 in the second region 325, as the second region 325 is the primary region for the first shard 151. Further, any data associated with the first shard 151 that is written to the second storage system 345 is now replicated by the second region 325 to the secondary regions, e.g., the first region 350 and third region 375.

In some embodiments, the first region 350 may become unavailable, e.g., due to a failure such as power failure, and therefore may not be used as the secondary region for the first shard 151, or any shard. The global shard manager may choose any other region, in addition to the third region 375, as the secondary region for the first shard 151. However, if available, the first region 350 can act as the secondary region for the first shard 151.

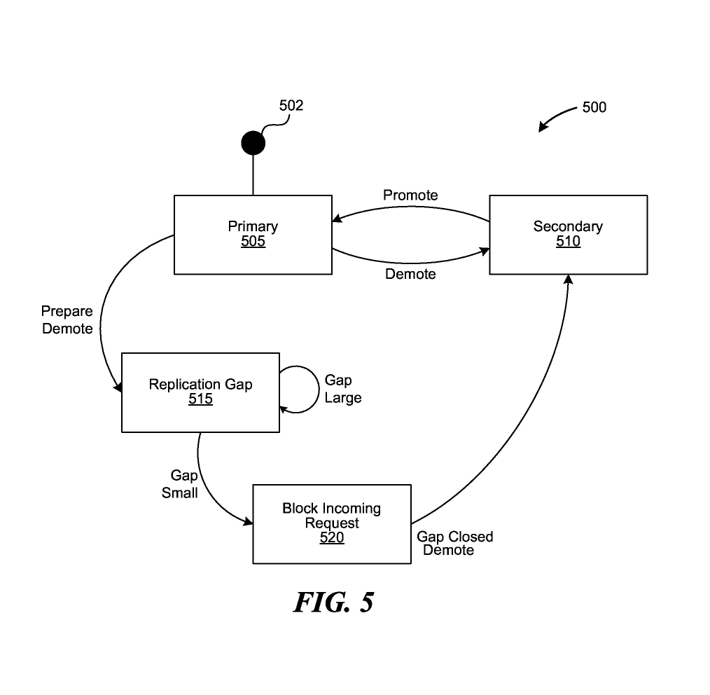

FIG. 5 is a state transition diagram 500 for failing over the application service from one region to another region, consistent with various embodiments. The global shard manager 205 can trigger the failover process by changing a state of a specified shard 502 by updating a value of an expected primary region attribute of the specified shard 502 from none to one of the regions. In the state transition diagram 500, the node 505 indicates a primary role of a region and the node 510 indicates a secondary role of a region. Upon noting the state change of the specified shard 502, the primary region 505 triggers a “prepare demote” process to prepare for demoting itself to the secondary region 510. The prepare demote process can check one or more criteria, e.g., replication lag 515, as described at least with reference to FIG. 3 above, to determine whether to demote the primary region 505 to the secondary region 510.

If the replication gap is large, the prepare demote process may not be completed and it may indicate to the global shard manager 205 that the failover process cannot be completed as the replication gap is above the specified threshold. In some embodiments, the prepare demote process can wait until the replication gap is below the specified threshold, and once the replication gap is below the specified threshold, a “gap small” process is initiated. The gap small process blocks any incoming data access requests (block 520) at the primary region 505 in order to further delay the replication or increase the replication lag. After the replication lag is zero, a “gap closed” process is initiated. The gap closed process can final demote the primary region 505 to the secondary region 510, and the “promote” process of the secondary region 510 can promote the secondary region 510 to being the primary region 505.

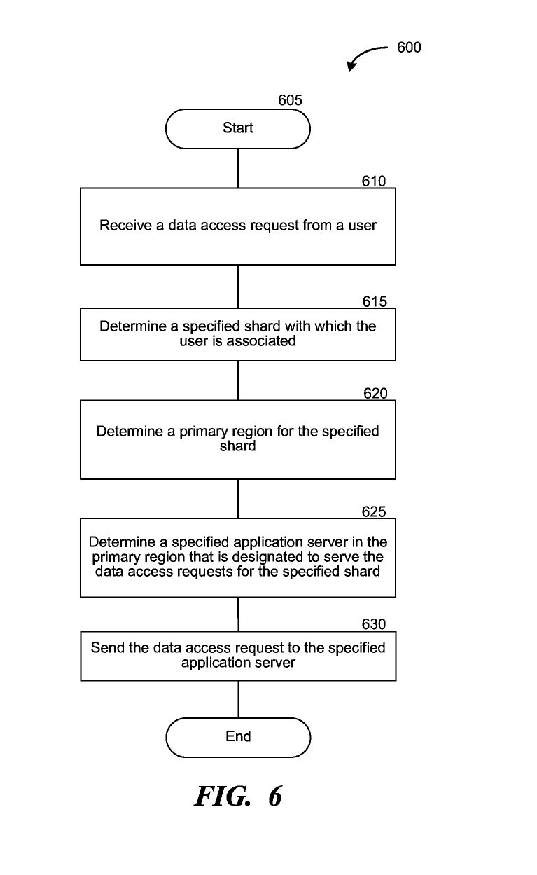

FIG. 6 is a flow diagram of a process 600 of routing a data access request from a user to an application server, consistent with various embodiments. In some embodiments, the process 600 may be implemented in the environment 300 of FIG. 3. The process 600 begins at block 605, and at block 610, the routing device 315 receives a request from a user via a client, e.g., the client 305, for a data access request. At block 615, the routing device 315 determines a specified shard with which the user is associated. The user to shard mapping, e.g., information regarding which users are associated with which shards are made available to the routing device via the global shard manager 205 and/or another service.

At block 620, the routing device 315 determines a primary region for the specified shard. For example, the routing device 315 requests the global shard manager 205 to determine the primary region for the specified shard. The global shard manager 205 can use the shard-region assignment table 225 to determine the primary region for the specified shard.

After the primary region is identified, at block 625, the routing device 315 determines the application server in the primary region that is assigned serve the data access requests for the specified shard. For example, the routing device 315 requests the first regional shard manager 327 in the primary region to determine the application server for the specified shard. The first regional shard manager 327 can use the shard-server assignment table 235 to determine the application server that serves the data access requests for the specified shard.

At block 630, the routing device 315 can send the data access request to the specified application server in the primary region.

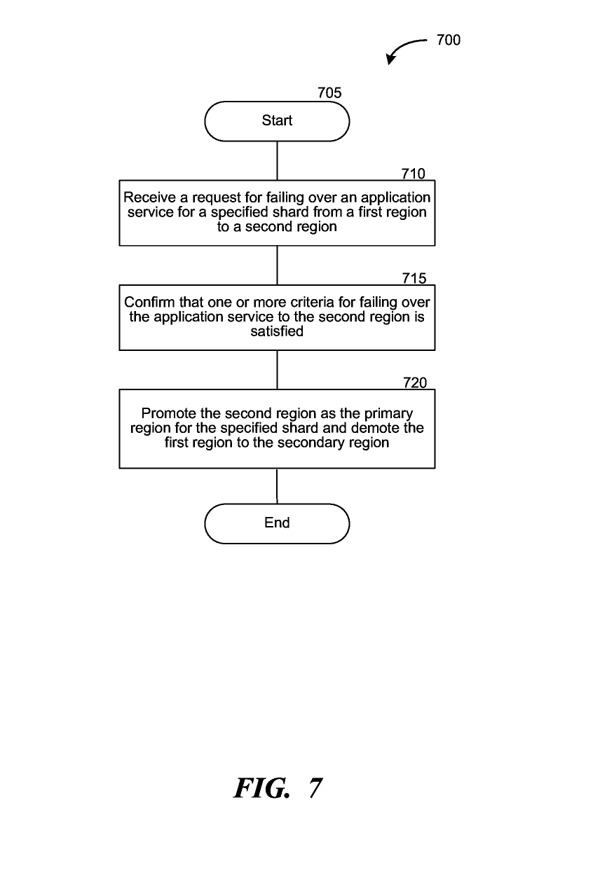

FIG. 7 is a flow diagram of a process 700 of failing over an application service from one region to another region, consistent with various embodiments. In some embodiments, the process 700 may be implemented in the environment 300 of FIG. 3. The process 700 begins at block 705, and at block 710, the global shard manager 205 receives a request for failing over the application service from the first region 350 to the second region 325. In some embodiments, the failover process 700 can be triggered by changing the expected primary of a specified shard, e.g., the first shard 151, to a specified region, e.g., the second region 325.

At block 715, the regional shard manager of the current primary region of the specified shard, e.g., the first regional shard manager 327 of the first region 350, confirms that one or more criteria for failing over the application service 110 to the second region 325 is satisfied.

At block 720, the first regional shard manager 327 instructs the regional shard manager of the expected primary region of the specified shard, e.g., the second regional shard manager 326 of the second region 325, to promote the second region 325 to the primary region for the specified shard. The first regional shard manager 327 can demote the first region 350 to the secondary region for the specified shard.

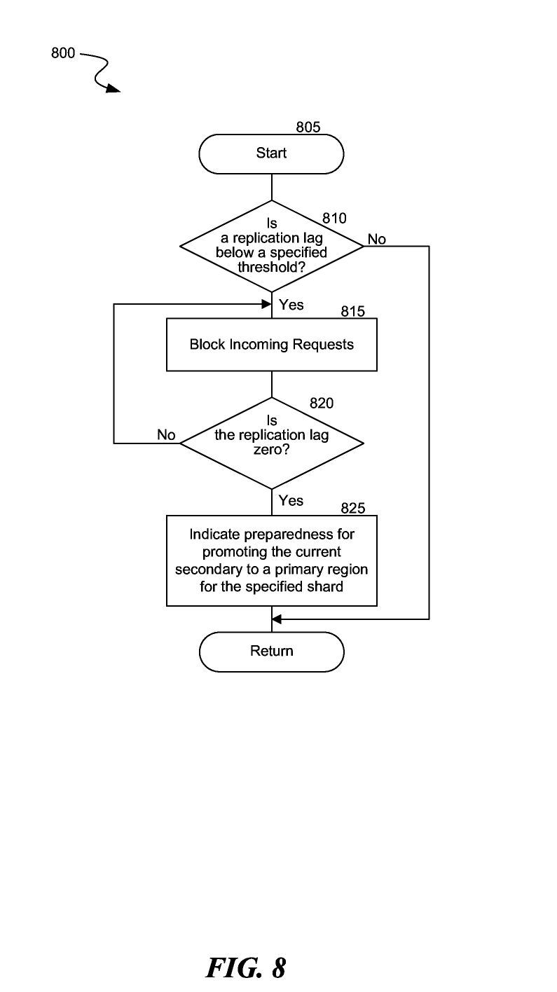

FIG. 8 is a flow diagram of a process 800 of confirming if one or more criteria for failing over an application service from one region to another region are satisfied, consistent with various embodiments. In some embodiments, the process 800 may be implemented in the environment 300 of FIG. 3 and may be part of the process performed in association with block 715 of FIG. 7. The process 800 begins at block 805, and at block 810, the regional shard manager of the current primary region of the specified shard, e.g., the first regional shard manager 327 of the first region 350, determines if a replication lag between the first storage system 365 of the first region 350 and the second storage system 345 of the second region 325 is below a specified threshold.

At block 815, if the replication is below the specified threshold, the first regional shard manager 327 blocks any incoming data access requests for the specified shard at the first region 350, e.g., in order to keep the replication lag from increasing. If the replication lag is not below the specified threshold, the first regional shard manager 327 can indicate the global shard manager 205 that the fail over process 800 cannot be continued since the replication lag is beyond the specified threshold, and the process 800 can return.

At block 820, the first regional shard manager 327 determines if the replication lag is zero, e.g., all data associated with the first shard 151 in the first storage system 365 is copied to the second storage system 345 at the second region 325.

If the replication lag is not zero, the process 800 waits until the replication lag is zero, and continues to block any incoming data access requests for the specified shard at the first region 350. If the replication lag is zero, the second regional shard manager 326 can indicate its preparedness for promoting the second region 325 to the primary region to the global shard manager 205. The process 800 can then continue with the process described at least with reference to block 720 of FIG. 7.

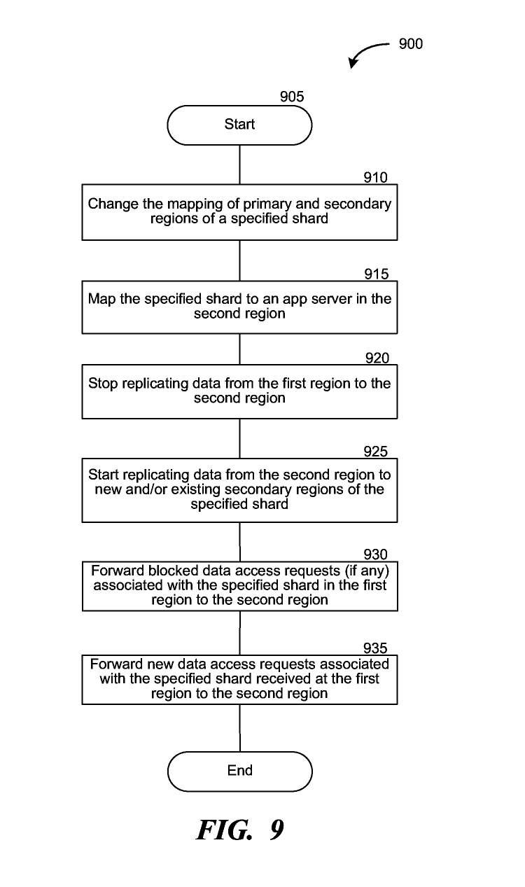

FIG. 9 is a flow diagram of a process 900 of promoting a region to the primary region of a specified shard, consistent with various embodiments. In some embodiments, the process 900 may be implemented in the environment 300 of FIG. 3 and can be part of the process described at least with reference to block 720 of FIG. 7. The process 900 begins at block 905, and at block 910, upon the regional shard manager of the expected primary region, e.g., the second regional shard manager 326 of the second region 325, promoting the second region 325 to the primary region, the global shard manager 205 changes the mapping of primary and secondary regions of the specified shard. For example, the global shard manager 205 can update the shard-region assignment table 225 to indicate that the second region 325 is the primary region for the first shard 151 and the first region 350 (if still available) is the or one of the secondary regions of the first shard 151.

At block 915, the second regional shard manager 326 also maps the specified shard to an application server in the second region 325. For example, the global shard manager 205 can update a region-shard mapping assignment table associated with the second region 325, such as the shard-region assignment table 225, to indicate that the first shard is mapped to the application server “A₂₁.”

At block 920, the first regional shard manager 327 can stop replicating data from the first region 350 to the second region 325. For example, the first regional shard manager 327 can instruct the first data server 370 to stop replicating the data associated with the first shard 151 to the second region 325.

At block 925, the second regional shard manager 326 can start replicating data associated with the specified shard from the second region 325 to the secondary regions of the specified shard. For example, the second data server 340 can replicate the data associated with the first shard 151 to the first region 350 and the third region 375.

At block 930, the first regional shard manager 327 forwards any blocked data access requests, e.g., that were blocked in as part of the process described at least with reference to block 815 of FIG. 8, associated with the specified shard in the first region 350 to the second region 325.

At block 935, the first regional shard manager 327 forwards any new data access requests received at the first region 350 that are associated with the specified shard to the second region 325.

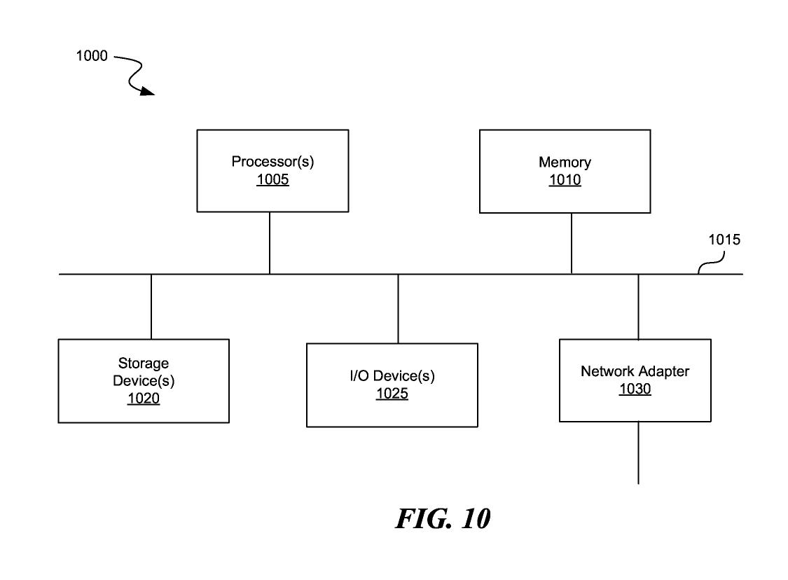

FIG. 10 is a block diagram of a computer system as may be used to implement features of the disclosed embodiments. The computing system 1000 may be used to implement any of the entities, components or services depicted in the examples of the foregoing figures (and any other components and/or modules described in this specification). The computing system 1000 may include one or more central processing units (“processors”) 1005, memory 1010, input/output devices 1025 (e.g., keyboard and pointing devices, display devices), storage devices 1020 (e.g., disk drives), and network adapters 1030 (e.g., network interfaces) that are connected to an interconnect 1015. The interconnect 1015 is illustrated as an abstraction that represents any one or more separate physical buses, point to point connections, or both connected by appropriate bridges, adapters, or controllers. The interconnect 1015, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus, also called “Firewire”.

The memory 1010 and storage devices 1020 are computer-readable storage media that may store instructions that implement at least portions of the described embodiments. In addition, the data structures and message structures may be stored or transmitted via a data transmission medium, such as a signal on a communications link. Various communications links may be used, such as the Internet, a local area network, a wide area network, or a point-to-point dial-up connection. Thus, computer readable media can include computer-readable storage media (e.g., “non transitory” media).

The instructions stored in memory 1010 can be implemented as software and/or firmware to program the processor(s) 1005 to carry out actions described above. In some embodiments, such software or firmware may be initially provided to the processing system 1000 by downloading it from a remote system through the computing system 1000 (e.g., via network adapter 1030).

The embodiments introduced herein can be implemented by, for example, programmable circuitry (e.g., one or more microprocessors) programmed with software and/or firmware, or entirely in special-purpose hardwired (non-programmable) circuitry, or in a combination of such forms. Special-purpose hardwired circuitry may be in the form of, for example, one or more ASICs, PLDs, FPGAs, etc.

### Remarks

The above description and drawings are illustrative and are not to be construed as limiting. Numerous specific details are described to provide a thorough understanding of the disclosure. However, in some instances, well-known details are not described in order to avoid obscuring the description. Further, various modifications may be made without deviating from the scope of the embodiments. Accordingly, the embodiments are not limited except as by the appended claims.

Reference in this specification to “one embodiment” or “an embodiment” means that a specified feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. Terms that are used to describe the disclosure are discussed below, or elsewhere in the specification, to provide additional guidance to the practitioner regarding the description of the disclosure. For convenience, some terms may be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way. One will recognize that “memory” is one form of a “storage” and that the terms may on occasion be used interchangeably.

Consequently, alternative language and synonyms may be used for any one or more of the terms discussed herein, nor is any special significance to be placed upon whether or not a term is elaborated or discussed herein. Synonyms for some terms are provided. A recital of one or more synonyms does not exclude the use of other synonyms. The use of examples anywhere in this specification including examples of any term discussed herein is illustrative only, and is not intended to further limit the scope and meaning of the disclosure or of any exemplified term. Likewise, the disclosure is not limited to various embodiments given in this specification.

Those skilled in the art will appreciate that the logic illustrated in each of the flow diagrams discussed above, may be altered in various ways. For example, the order of the logic may be rearranged, substeps may be performed in parallel, illustrated logic may be omitted; other logic may be included, etc.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

I/We claim:

1. A method performed by a computing system, comprising:
receiving, at a global shard manager executing at a computing device, a request for failing over an application service executing at a first set of server computing devices located in a first region to a second set of server computing devices located in a second region, the application service managing data associated with multiple users of the application service as multiple shards, wherein a specified shard of the multiple shards includes data associated with a subset of the users, wherein the first region is designated as a primary region for the specified shard and the second region is designated as a secondary region for the specified shard, and wherein data access requests from users associated with the specified shard are served by a set of server computing devices in the primary region;
determining, by a first regional shard manager executing at another computing device in the first region, whether one or more criteria for failing over the application service to the second region is satisfied; and
responsive to determination that the one or more criteria is satisfied, promoting, by the global shard manager, the second region to the primary region for the specified shard and demoting the first region to the secondary region for the specified shard.

2. The method of claim 1, wherein determining whether one or more criteria is satisfied includes:
confirming, by the first regional shard manager, that a replication lag of data associated with the specified shard from a first storage system associated with the first region to a second storage system associated with the second region is below a specified threshold, and
blocking, by the first regional shard manager, data access requests from the users associated with the specified shard.

3. The method of claim 2 further comprising:
confirming, by the first regional shard manager, that a replication of the data associated with the specified shard from the first storage system to the second storage system has completed successfully, and
sending, by the first regional shard manager, a notification to the global shard manager indicating a completion of the replication.

4. The method of claim 2, wherein promoting the second region to the primary region includes forwarding the data access requests that are blocked to the second region.

5. The method of claim 1, wherein determining whether one or more criteria is satisfied includes:
confirming, by the first regional shard manager, that a replication lag of data associated with the specified shard from a first storage system associated with the first region to a second storage system associated with the second region is exceeds a specified threshold, and
sending, by the first regional shard manager, a notification to the global shard manager indicating that the application service cannot be failed over.

6. The method of claim 1, wherein promoting the second region to the primary region includes setting up multiple processes associated with the application service to execute at one or more the second set of servers.

7. The method of claim 1 further comprising:
forwarding data access requests from the users associated with the specified shard to the second set of servers in the second region.

8. The method of claim 7, wherein the second set of servers process the data access requests from the users using a second storage system associated with the second region, the second storage system being different from a first storage system associated with the first region using which the first region processes the data access requests.

9. The method of claim 1, wherein promoting the second region to the primary region includes preventing a second regional shard manager associated with the second region from forwarding data access requests from the users associated with the specified shard to the first region.

10. The method of claim 1, wherein promoting the second region to the primary region includes starting a replication service to replicate data associated with specified shard from a second storage system associated with the second region to one or more storage systems associated with one or more of multiple regions.

11. The method of claim 1, wherein demoting the first region to the secondary region includes preventing the second region from accepting data access requests from the users associated with the specified shard.

12. The method of claim 1 further comprising:
receiving, at a request routing computing device, a data access request from a user of the users, the user being associated with a first shard of the shards;
determining, using the global shard manager, a third region as the primary region designated for the first shard;
determining, using a third regional shard manager associated with the third region, a server computing device of a third set of server computing devices in the third region that is associated with the first shard; and
forwarding, by request routing computing device, the data access request to the server computing device.

13. The method of claim 1 further comprising:
receiving an indication that a first server computing device of the second set of server computing devices is failing; and
failing over the application service from the first server computing device to a second server computing device of the second set of server computing devices in response to receiving the indication.

14. The method of claim 13, wherein failing over the application service includes:
determining a shard of the multiple shards with which the first server computing device is associated;
disassociating the first server computing device from the shard; and
associating the second server computing device with the shard.

15. A computer-readable storage medium storing computer-readable instructions, comprising:
instructions for receiving, at a request routing computing device, a data access request from a user of multiple users of an application service, the user being associated with a specified shard of multiple shards, the specified shard storing data associated with a subset of the users;
instructions for forwarding the data access request to a first server computing device in a first set of server computing devices located in a first region of multiple regions, wherein the first region is designated as a primary region for the specified shard and the first server computing device is a server computing device in the first region that is assigned to process data access requests associated with the specified shard;
instructions for determining that the application service is failed over to a second set of server computing devices in a second region of the multiple regions, wherein the second region is designated as the primary region for the specified shard in response to the fail over; and
instructions for forwarding data access requests from users associated with the specified shard to the second set of server computing devices.

16. The computer-readable storage medium of claim 15, wherein the instructions for determining that the application service is failed over to the second set of server computing devices in the second region include:
instructions for receiving, at a first regional shard manager of the first region, an indication to fail over the application service from the first region to the second region, the indication indicating that an expected primary region of the specified shard is changed to the second region,
instructions for determining, using the first regional shard manager whether one or more criteria for failing over the application service is satisfied, and
instructions for failing over the application service to the second region if the one or more criteria is satisfied, the failing over including assigning the second region as the primary region, the first region as a secondary region for the specified shard, and removing the second region as the expected primary region of the specified shard.

17. The computer-readable storage medium of claim 16, wherein the instructions for determining whether the one or more criteria is satisfied include:
instructions for confirming, by the first regional shard manager, that a replication of data associated with the specified shard from a first storage system associated with the first region to a second storage system associated with the second region has completed successfully.

18. The computer-readable storage medium of claim 15, wherein the instructions for determining that the application service is failed over to the second set of server computing devices in the second region include:
instructions for determining that at least some or the first set of server computing devices have failed, and
instructions for assigning the second region as the primary region of the specified shard regardless of a replication lag between a first storage system associated with the first region to a second storage system associated with the second region.

19. A system, comprising:
a processor;
a first component configured to receive a request for failing over an application service executing at a first set of server computing devices located in a first region to a second set of server computing devices located in a second region;
a second component configured to designate one of multiple regions as a primary region and one or more of the multiple regions as a secondary region for a specified shard of multiple shards, wherein the specified shard includes data associated with a subset of multiple users of the application service, wherein the first component is configured to assign the first region as the primary region and the second region as the secondary region for the specified shard; and
a third component configured to determine whether one or more criteria for failing over the application service to the second region is satisfied, wherein the second component is configured to promote the second region to the primary region and demote the first region to the secondary region for the specified shard if the one or more criteria is satisfied.

20. The system of claim 19, wherein the third component is further configured to determine whether the one or more criteria is satisfied by:
determining whether a replication of the data associated with the specified shard from a first storage system associated with the first region to a second storage system associated with the second region has completed successfully,
responsive to a determination that the replication has completed successfully, sending a notification to the second component to promote the second region as the primary,
responsive to a determination that the replication has not completed successfully,
determining that replication lag is below a specified threshold, and
blocking data access requests from the users associated with the specified shard until the replication lag is below the specified threshold.
